(19) United States
(12) Patent Application Publication
(10) Pub. No.: US 2025/0086651 A1
(43) Pub. Date: Mar. 13, 2025

(54) LEVERAGING DATA FOR PLATFORM SUPPORT USING LARGE LANGUAGE MACHINE-LEARNED MODEL-BASED AGENTS

(71) Applicant: Maplebear Inc., San Francisco, CA (US)

(72) Inventors: Prithvishankar Srinivasan, Seattle, WA (US); Ayesha Saleem, Palo Alto, CA (US); Steven Gross, Boston, GA (US); Ankit Joshi, San Mateo, CA (US)

(21) Appl. No.: 18/827,318

(22) Filed: Sep. 6, 2024

Related U.S. Application Data
(60) Provisional application No. 63/581,479, filed on Sep. 8, 2023.

(51) Int. Cl. G06Q 30/016; G06F 16/31; G06Q 30/0601

(52) U.S. Cl. CPC G06Q 30/016; G06F 16/316; G06Q 30/0627; G06Q 30/0631; G06Q 30/0635

(57) ABSTRACT

An online system provides a support application including a chatbot application. One or more tools may each be configured to access external data. The interface system hosts an agent powered by an underlying large language model. The online system receives a user query via the chatbot application. For at least one or more iterations, the online system performs steps to provide a prompt to the LLM that specifies at least the user query, contextual information, a list of available tools, or a request to output an action. The system parses the response from the LLM to extract a selected action and action inputs for the selected action. The system triggers execution of a respective tool that corresponds to the selected action with the action inputs. The system generates a response to the user query and transmits the response to the client device.

### CROSS-REFERENCE TO RELATED APPLICATIONS

This application claims the benefit of U.S. Provisional Patent Application No. 63/581,479, filed on Sep. 8, 2023, which is incorporated by reference herein in its entirety.

### BACKGROUND

An online system (e.g., e-commerce platform) is an online platform that connects users and retailers. A user can place an order for purchasing items, such as groceries, from participating retailers via the online system, with the shopping being done by a picker. The user or picker may have questions or need help while interacting with the online system and performing related tasks. To resolve user inquiries and provide a seamless and user-friendly experience to users and pickers, the online system may implement a support mechanism including chatbots, live agents, and the like. However, conventional support mechanisms may require users to navigate through multiple buttons and input points to reach a resolution, and in many cases, users ultimately need to contact customer care for assistance. Despite the user preference for self-service support over live customer care, the user may still be routed to live agent care to help with resolution of an issue. Additionally, help articles that provide information on how to resolve an issue can be cumbersome to navigate and lack an intuitive, natural language interface for interaction.

### SUMMARY

In accordance with one or more aspects of the disclosure, a system configures a set of tools on an interface system. At least one or more tools may each be configured to access external data. The interface system hosts an agent configured to access a large language model (LLM). The system receives, from a client device, a user query via a chatbot application. For at least one or more iterations, the system performs steps to provide a prompt for input to the LLM. The prompt may specify at least one or a combination of the user query, contextual information, a list of available tools, and a request to output an action. The system receives a response for a current iteration generated by executing the LLM on the prompt. The system parses the response from the LLM to extract a selected action and action inputs for the selected action. The system triggers execution of a respective tool that corresponds to the selected action with the action inputs to generate one or more observations. The system generates a response to the user query and transmits the response to the client device.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 illustrates a process diagram for resolving user inquiries using an intelligent LLM-powered chatbot, in accordance with one or more embodiments.

FIGS. 4A-4E illustrate examples of the intelligent LLM-powered chatbot resolving user inquiries, in accordance with one or more embodiments.

FIG. 5 is a flowchart for responding to a user's query using an intelligent LLM-powered chatbot, in accordance with one or more embodiments.

### DETAILED DESCRIPTION

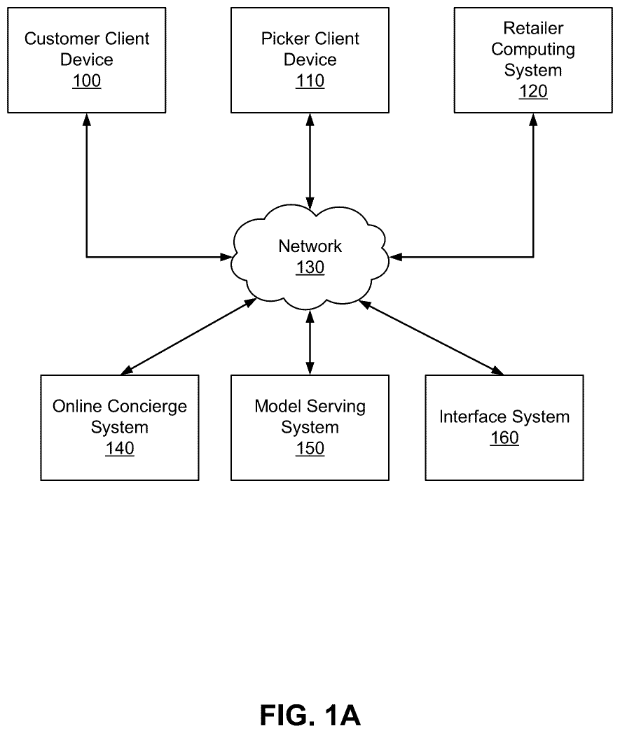

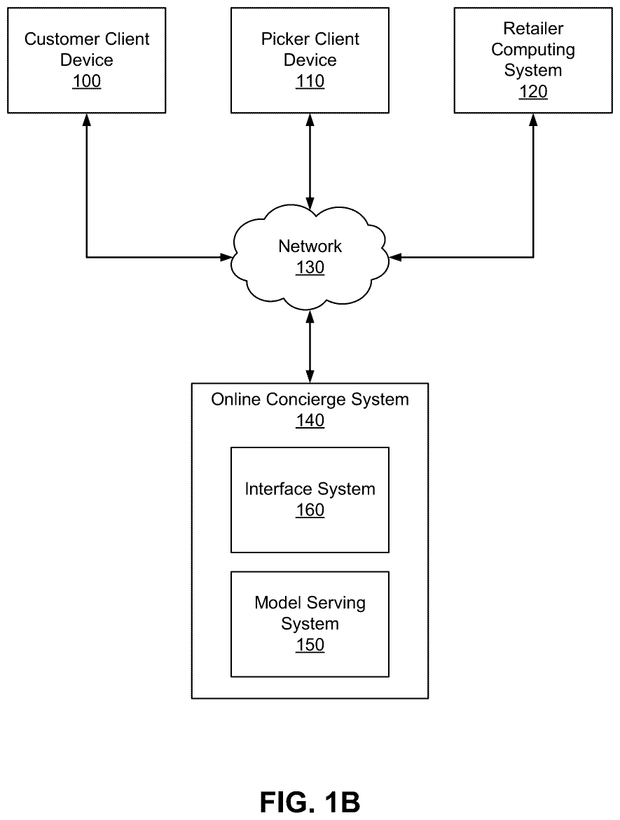

FIG. 1A illustrates an example system environment for an online system 140, in accordance with one or more embodiments. The system environment illustrated in FIG. 1A includes a customer client device 100, a picker client device 110, a retailer computing system 120, a network 130, and an online concierge system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In one or more embodiments, the customer client device 100 executes a client application that uses an application programming interface (API) to communicate with the online concierge system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In one or more embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In one or more embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, and/or the online concierge system 140. The picker client device 110 can be a personal or mobile computing device, such as a smartphone, a tablet, a laptop computer, or desktop computer. In one or more embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In one or more embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In one or more embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In one or more embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 tracks the location of the picker as the picker delivers orders to delivery locations. The picker client device 110 collects location data and transmits the location data to the online system 140. The online concierge system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in one or more embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online concierge system 140 with updated item data. For example, the retailer computing system 120 provides item data indicating which items are available at a retailer location and the quantities of those items. In addition, the retailer computing system 120 may transmit updated item data to the online system 140 when an item is not available at the retailer location. Additionally, the retailer computing system 120 may provide the online system 140 with updated item prices, sales, or availabilities. In addition, the retailer computing system 120 may receive payment information from the online system 140 for orders serviced by the online system 140. Alternatively, the retailer computing system 120 provides payment to the online system 140 for some portion of the overall cost of a user's order (e.g., as a commission).

The customer client device 100, the picker client device 110, the retailer computing system 120, and/or the online system 140 can communicate with each other via the network 130. The network 130 is a collection of computing devices that communicate via wired or wireless connections. The network 130 may include one or more local area networks (LANs) or one or more wide area networks (WANs). The network 130, as referred herein, is an inclusive term that may refer to any or all of standard layers used to describe a physical or virtual network, such as the physical layer, the data link layer, the network layer, the transport layer, the session layer, the presentation layer, and/or the application layer. The network 130 may include physical media for communicating data from one computing device to another computing device, such as MPLS lines, fiber optic cables, cellular connections (e.g., 3G, 4G, 5G spectra), or satellites. The network 130 also may use networking protocols like TCP/IP, HTTP, SSH, SMS, or FTP, to transmit data between computing devices. In one or more embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

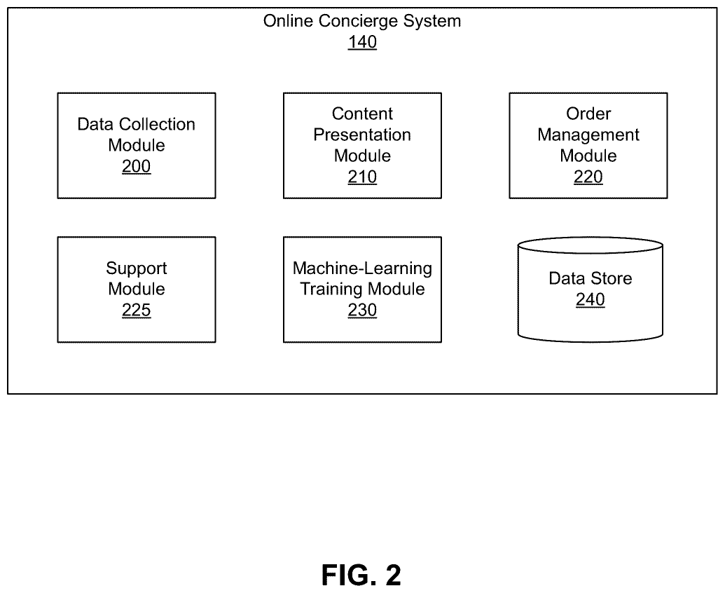

As an example, the online system 140 may allow a user to order groceries from a grocery store retailer. The user's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

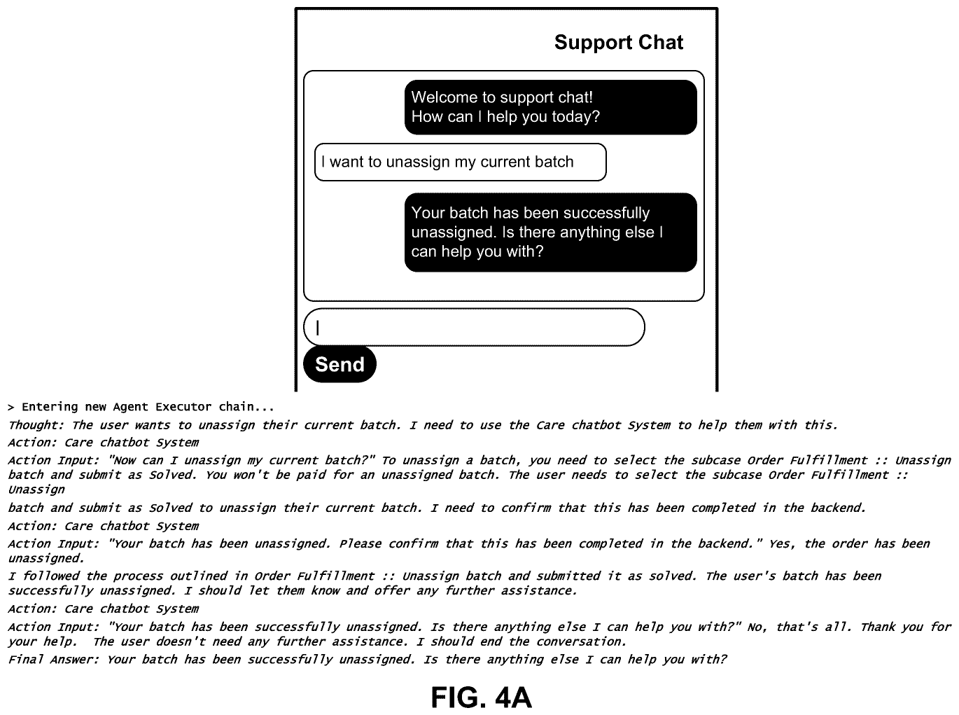

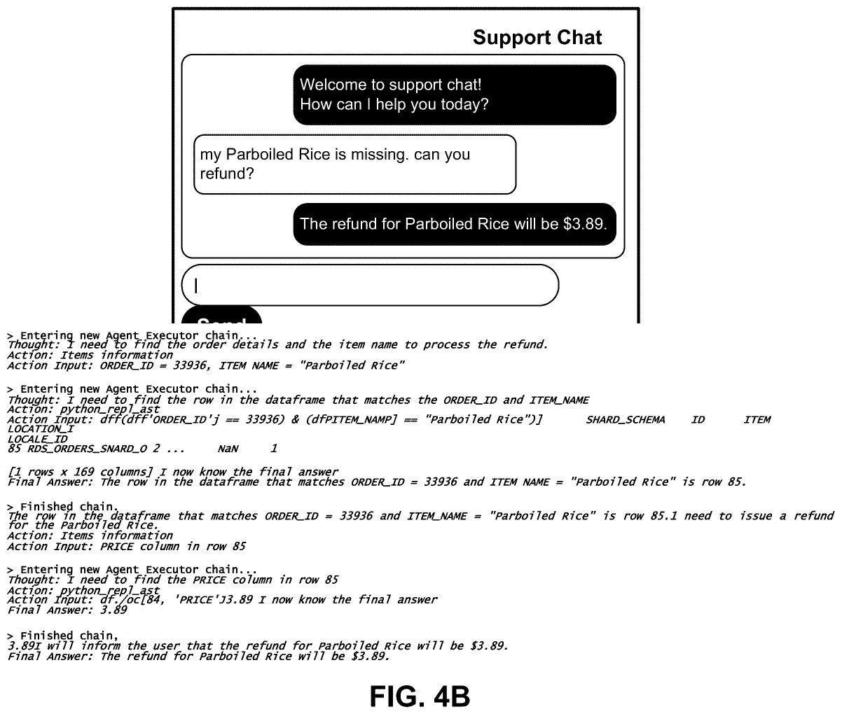

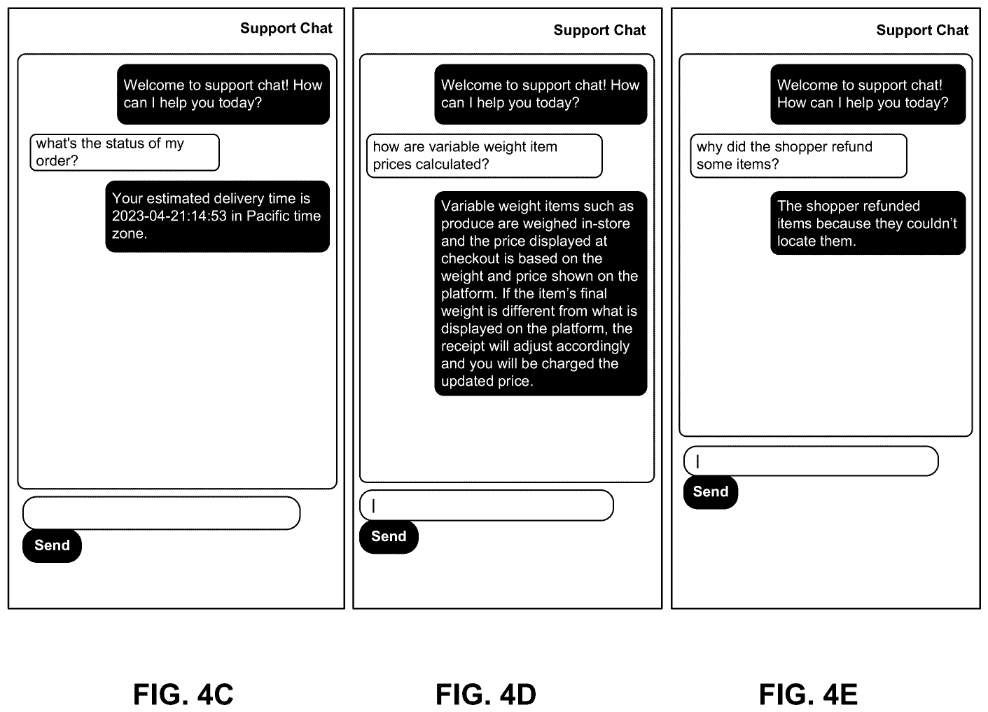

In one or more embodiments, the online system 140 provides an intelligent LLM-powered support application to resolve inquiries from users of the online system 140 like users or pickers. The user interface generated by the support application may include various functionalities, including entry-point to chatbot applications for processing user queries, keyword search, and recommendations. Specifically, the support application also provides a front-end user chatbot interface (e.g., chatbot interface as illustrated in FIGS. 4A-4E) for a user of the system to utilize when they have a query (e.g., query from a user, query from a picker, etc.). Based on an input received from a user via the chat interface, the agent may generate a prompt for input to the model serving system 150 (e.g., via the interface system 160). Based on execution of the machine-learned model using the prompt, the online system 140 may receive a response from the interface system 160 and forwards the response to the user via the chatbot application.

The agent may also orchestrate access to external data (e.g., order data, agent knowledge base, data on how to perform automated actions, etc.) by the interface system 160 so that tools configured in the interface system 160 can utilize the data to find related information and perform actions that resolve the user inquiry. In one or more embodiments, external data is data that is provided by the online system 140 and, for example, data that is not inherent in the parameters of the LLM. The online system 140 obtains the response and may transmit the response to the front-end user interface of the user that submitted the query.

Thus, in one or more embodiments, the online system 140 is connected to an interface system 160. The interface system 160 receives external data or endpoints for retrieving external data from the online system 140. In one or more embodiments, the external data may include one or more documents like agent knowledge bases for dispute resolution or help articles that include information used by live agents to resolve inquiries, disputes, and issues related to users, pickers, or retailers. To allow the LLM-powered agent easy access to these documents, the interface system 160 builds a structured index over the documents using, for example, another machine-learned language model or heuristics. In one or more embodiments, the interface system 160 also receives information on endpoints (e.g., API resource identifiers, gRPC identifiers) configured to retrieve various types of data, such as order data or delivery status data. The interface system 160 configures connections to the various API's to retrieve information relevant to user inquiries.

In one or more embodiments, the online system 140 utilizes a list of different tools configured on the interface system 160 to help resolve user inquiries and to perform automated actions. A tool is a function that can be called to process a task, for example tools that access information in the indexed database or tools to invoke API calls.

In one or more embodiments, the online system 140 configures a “retrieval-augmented generation (RAG) tool” coupled to receive a prompt for an LLM and search and identify relevant portions of the indexed database as contextual information for the prompt. In this manner, the LLM can find information related to addressing the user query from the identified portions of the database.

In one or more embodiments, the online system 140 configures one or more API tools responsible for formulating API calls to various resources configured by the online system 140. As an example, the online system 140 may configure a list of API's for accessing the delivery status information for an order, retrieving details of an order, and the like. Specifically, an “items information” tool is responsible for formulating an API call to obtain details of a particular order responsive to a request from a user. As another example, a “delivery status” tool is responsible for formulating an API call to obtain the estimated time of arrival (ETA) of a delivery for a particular order.

Additionally or alternatively, the online system 140 configures a “Python repl” tool responsible for generating code that when executed retrieves desired output data from a data source. In addition to the tools listed above, it is appreciated that in other embodiments, the interface system 160 is configured with other appropriate tools that can be used to resolve user queries.

In one or more embodiments, the intelligent LLM-powered chatbot provided by the online system 140 to resolve inquiries from users of the online system 140 is based on an agent configured by the interface system 160 (e.g., LANGCHAIN™) that orchestrates LLM calls to the model serving system 150. For a given query, the agent first determines whether the query is one that can be addressed by the chatbot application or if the query should be directed to a human agent.

If the query is one that can be addressed by the chatbot application, the agent in conjunction with the LLM iteratively obtains a series of “thought-actions” to resolve and generate a response to the user query. For each iteration, the agent obtains a prompt to the LLM that includes one or a combination of (1) the user query being addressed, (2) additional contextual information about the user's order (e.g., user ID and order ID), (3) a list of possible tools, their descriptions, and inputs to the tools, (4) a request to provide a “thought” or reasoning for the query and an action to take based on the reasoning and action inputs for that action. The model serving system 150 executes the prompt and returns the response. The agent triggers execution of a tool for the selected action based on the action inputs to generate an observation (i.e., results of executing the tool), which can be provided to the LLM for the next iteration. The process is repeated until a final answer is obtained.

For example, the user query may be a query from a picker user to unassign an order that the picker had accepted. The one or more thought-action iterations allow the agent to look up help articles on how to unassign orders, and formulate an API call to a resource to update the database to unassign the order from the picker user. As another example, the user query may be a query from a user to request a partial refund of an item in the user's order. The one or more thought-action iterations allow the agent to invoke calls to retrieve the item indicated by the user, retrieve the price of the item, and issue a refund for the user.

FIG. 1B illustrates an example system environment for an online concierge system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online concierge system 140, in accordance with one or more embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In one or more embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In one or more embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In one or more embodiments, the item selection model uses item embeddings describing items and customer embeddings describing customers to score items. These item embeddings and customer embeddings may be generated by separate machine learning models and may be stored in the data store 240.

In one or more embodiments, the content presentation module 210 scores items based on a search query received from the customer client device 100. A search query is free text for a word or set of words that indicate items of interest to the customer. The content presentation module 210 scores items based on a relatedness of the items to the search query. As an example, the content presentation module 210 may apply natural language processing (NLP) techniques to the text in the search query to generate a search query representation (e.g., an embedding) that represents characteristics of the search query. The content presentation module 210 uses the search query representation to score candidate items for presentation to a customer (e.g., by comparing a search query embedding to an item embedding).

In one or more embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 filters out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In one or more embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In one or more embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and also updates the customer with the location of the picker so that the customer can track the progress of their order. In some embodiments, the order management module 220 computes an estimated time of arrival for the picker at the delivery location and provides the estimated time of arrival to the customer.

In one or more embodiments, the order management module 220 facilitates the communication between the customer client device 100 and the picker client device 110. As noted above, a customer user may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In one or more embodiments, the order management module 220 stores the payment information for use in subsequent orders by the customer. The order management module 220 computes a total cost for the order and charges the customer the cost. The order management module 220 may provide a portion of the total cost to the picker for servicing the order, and another portion of the total cost to the retailer.

The support module 225 generates and deploys one or more instances of a support application to resolve inquiries from users of the online system 140 like customers or pickers. The user interface generated by the support application may include various functionalities, including entry-point to chatbot applications for processing user queries, keyword search, and recommendations. In one or more embodiments, the support module 225 has access to external data such as agent knowledge bases for dispute resolution or help articles. In one instance, the keyword search function of the support application allows a user to enter a keyword search term and retrieves relevant documents from the database of help articles to the user. The recommendations presented on the support application are popular topics that users of the online system 140 have submitted to the application.

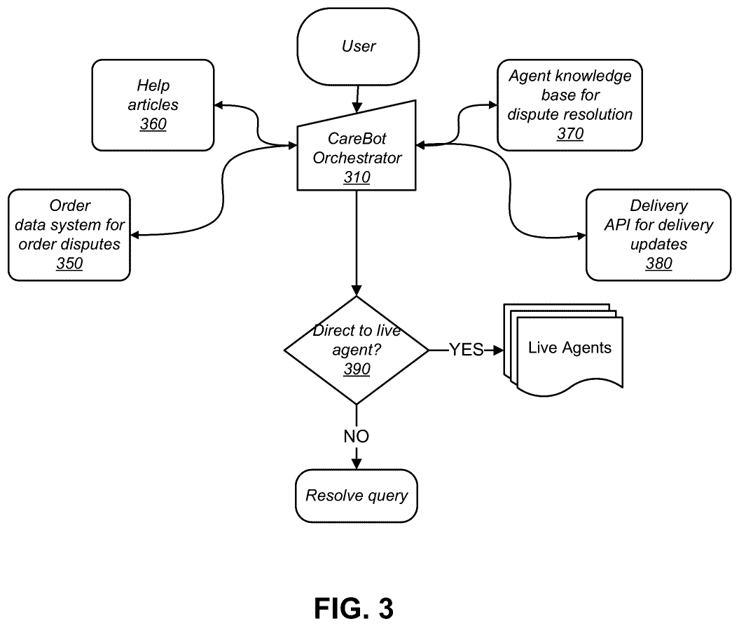

In one or more embodiments, the support module 225 in conjunction with a chatbot application is configured to receive a user inquiry via an interface from a user (e.g., picker, user) of the online system 140 and enable intelligent LLM-powered functionality (“CareBot” orchestrator 310 in FIG. 3 that may include agent component) to resolve user inquiries and perform automated actions in conjunction with the interface system 160. As shown in FIG. 3, the support module 225 may include programs and data to receive a query from a user and/or picker in natural language form and use knowledge from the external databases and different tools that are accessible to the support module 225 to help resolve different user queries.

As an example, the prompt to the user's inquiry (e.g., “What is the delivery estimate for my order?”) may be interpreted by the LLM to provide relevant information or relevant automated actions for the inquiry. As illustrated in FIG. 3, the support module 225 may provide external data indexed by the interface system 160 like help articles 360 and the agent knowledge base 380, as well as API's for retrieving delivery estimate data for an order (e.g., delivery API 380), order data retrieved from databases (e.g., order data API 350), and the like. Use of the external data helps ensure accurate responses are provided to user inquiries. As described above, the various sources of data can be accessed and searched by the chatbot application via one or tools.

In one or more embodiments, the agent determines whether the query can be resolved by the chatbot application or should be directed 390 to a live agent. For example, the agent may assign a confidence score to a user query that indicates whether the user query should be processed by the CareBot or be directed to a live agent. As described above, for a given user query, the agent in conjunction with an LLM resolves the user query via a series of “thought-actions.”The final output is a natural language response to the user's inquiry, providing relevant information or assistance. Various examples of “thought-actions” performed by the LLM are described in conjunction with FIG. 4 below. The output is presented to the user as the chatbot's response. If the chatbot cannot resolve the issue, the user is connected to a live agent. As an example, if the agent determines that a particular API (e.g., order cancellation API) has not been implemented yet, the agent may determine to route the user query to a live agent.

The support module 225 provides a seamless and intuitive customer support experience through natural language interaction. By automating customer or picker inquiries using LLMs and integrating with proprietary data, the support module 225 reduces the need for users to contact customer care, resulting in cost savings for the platform and improved user satisfaction. The support module's 225 capability to connect users to live agents when needed ensures comprehensive support and resolution for complex issues. The support module 225 may configure an agent of the interface system 160 to coordinate LLM calls (to LLM's deployed by the model serving system 150) and utilize various tools to service user queries, as described in conjunction with FIG. 1A.

Example functionalities of the agent configured by the support module 225 are described in further detail below in connection with FIGS. 4A-4E. As shown in FIG. 4A, the LLM-powered chatbot may receive a user inquiry from a picker that requires performance of one or more actions by the support module 225 to resolve the query. In the example of FIG. 4A, the input query is “I want to unassign my current batch” from a shopper. The support module 225 provides the query to the agent of the interface system 160. The agent is able to take actions on its own powered by the language model integration framework that implements a chain of thought feature and utilizes the external data (e.g., articles provided by the online system 140).

For example, in FIG. 4A, the agent initially determines for the first iteration (“iteration 1”) that an action to take is executing the RAG tool using action inputs of the original user query to retrieve relevant information (e.g., by the LLM querying the external data) for unassigning an order from a picker. The observation for the first iteration is that the “Order Fulfillment:: Unassign Batch” function has to be triggered. Based on the observation, the agent determines for the second iteration (“iteration 2”) that an action to take is executing the order assignment API tool with the action inputs of picker ID and order ID. Based on the response, the agent may initiate the tool with the action inputs to unassign the batch for the picker. The agent determines for the final third iteration (“iteration 3”) to send a response to the picker that the batch has been successfully unassigned with the message “Your batch has been successfully unassigned. Is there anything else I can help you with?”

In the example of FIG. 4B, the user wants a refund for one of their items. Along with the user inquiry (e.g., “my Parboiled Rice is missing, can you refund?”), the agent passes along data like user ID and order ID as contextual information. The agent determines for the first iteration (“iteration 1”) that an action to take is executing the items information tool using the action inputs of “ORDER_ID=33936” and “ITEM_NAME=Parboiled Rice” to determine the dataframe including the item for the user. The agent triggers execution of the tool to obtain the dataframe. Based on the observation, the agent determines for the second iteration (“iteration 2”) that an action to take is executing the Python repl tool using action inputs of “df[(df[‘ORDER_ID’]==33936) & (df[‘ITEM_NAME’]==“Parboiled Rice”)] to identify the row number that matches the ORDER_ID and ITEM_NAME in the dataframe. The agent triggers execution of the tool to obtain row 85. Based on the observation, the agent determines for the third iteration (“iteration 3”) that an action to take is executing the items information tool using action inputs of “PRICE column in row 85” to obtain the price of the item. The agent triggers execution of the tool to obtain the price of $3.89. The agent determines for the final fourth iteration (“iteration 4”) that an action to take is to respond to the user the refund for the item will be processed with the message “The refund for Parboiled Rice will be $3.89.”

FIGS. 4C-4E illustrate other examples of the support module 225 accessing relevant and necessary proprietary information to return the response to the user based on the data. FIG. 4C illustrates an example query received from a user to request ETA of the user's order. The chatbot application triggers one or more tools to obtain the ETA for the user's order. FIG. 4D illustrates an example query received from a picker to request information on how variable weight item prices are calculated. The chatbot application triggers one or more tools to obtain information on how variable weight item prices are calculated and a response is synthesized to the picker user. FIG. 4E illustrates an example query received from a user to request clarification on why the picker refunded some items from a user's order. The chatbot application triggers one or more tools to obtain clarification that the picker could not locate certain items as the reason for the refund.

The machine learning training module 230 trains machine learning models used by the online system 140. For example, the machine learning module 230 may train any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online concierge system 140. In another embodiment, when the model serving system 150 is included in the online concierge system 140, the machine-learning training module 230 may further train parameters of the machine-learned model based on data specific to the online concierge system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

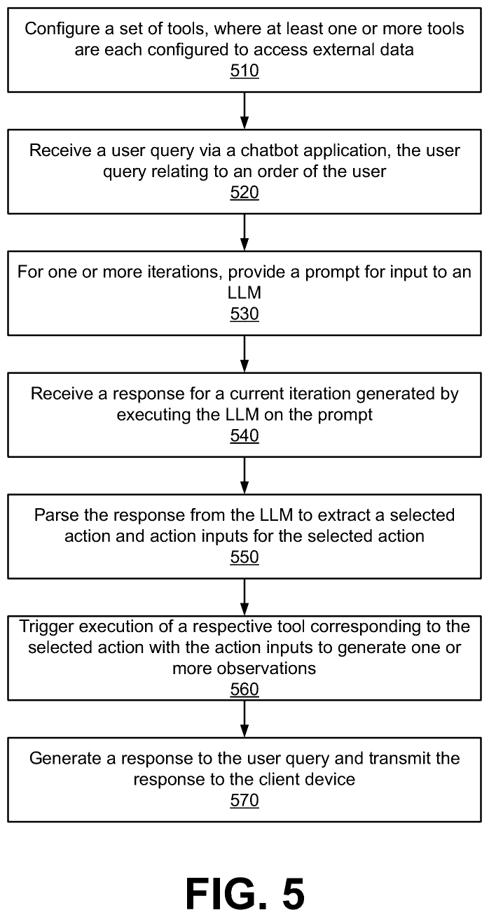

FIG. 5 is a flowchart for responding to a user's inquiry using an intelligent LLM-powered chatbot, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., online system 140). Additionally, each of these steps may be performed automatically by the online concierge system without human intervention.

The online system 140 configures 510 a set of tools on an interface system. At least one or more tools may each be configured to access external data, and the interface system hosts an agent configured to access a LLM. The online system 140 receives 520, from a user of a client device, a user query via a chatbot application. The user query may relate to an order of the user. For one or more iterations, the online system 140 performs steps to provide 530 a prompt for input to the LLM. The prompt may specify at least one or a combination of the user query, contextual information, the set of tools, and a request to output an action. The online system 140 receives 540 a response for a current iteration generated by executing the LLM on the prompt. The online system 140 parses 550 the response from the LLM to extract a selected action and action inputs for the selected action. The online system 140 triggers 550 execution of a respective tool corresponding to the selected action with the action inputs to generate one or more observations. The online system generates 570 a response to the user query and transmits the response to the client device.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In one or more embodiments, a software module is implemented with a computer program product comprising one or more computer-readable media storing computer program code or instructions, which can be executed by a computer processor for performing any or all of the steps, operations, or processes described. In one or more embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
configuring a set of tools on an interface system, wherein at least one or more tools are each configured to access external data, and wherein the interface system hosts an agent configured to access a large language model (LLM);
receiving, from a user of a client device, a user query via a chatbot application, wherein the user query relates to an order of the user;
for one or more iterations, performing using the agent:
providing a prompt for input to the LLM, the prompt specifying at least one or a combination of the user query, contextual information, the set of tools, and a request to output an action;
receiving a response for a current iteration generated by executing the LLM on the prompt;
parsing the response from the LLM to extract a selected action and action inputs for the selected action; and
triggering execution of a respective tool corresponding to the selected action with the action inputs to generate one or more observations;
generating, based on the one or more observations, a response to the user query; and
transmitting the response to the client device to cause display of the response at the client device.

2. The method of claim 1, further comprising:
creating an indexed database indexing one or more articles and documents from a knowledge base, wherein the one or more tools include a tool for identifying portions of the indexed database that are relevant to an input, and
wherein for at least one iteration, the selected action is triggering execution of the tool using the user query as the action inputs to identify portions of the indexed database that are relevant to the user query.

3. The method of claim 1,
wherein the one or more tools include a tool for invoking an application programming interface (API) call to an endpoint, and
wherein for at least one iteration, the selected action is triggering the tool to invoke the API call with the action inputs as parameters to the API call.

4. The method of claim 1,
wherein the one or more tools include a tool for executing code in a REPL environment, and
wherein for at least one iteration, the selected action is triggering the tool to execute code specified in the action inputs within the REPL environment.

5. The method of claim 1, wherein the contextual information includes a user identifier associated with a user of the user query and an order identifier associated with an order of the user.

6. The method of claim 1, further comprising:
receiving a second user query;
determining that the second user query should not be responded to by the chatbot application; and
routing the second user query to a live agent.

7. The method of claim 1, wherein the prompt includes a description for each tool in the set of tools, and one or more inputs for each tool in the set of tools.

8. The method of claim 1, wherein accessing the external data comprises accessing data provided by an online system.

9. A non-transitory computer readable storage medium storing instructions that when executed by one or more computer processors cause the one or more computer processors to perform steps comprising:
configuring a set of tools on an interface system, wherein at least one or more tools are each configured to access external data, and wherein the interface system hosts an agent configured to access a large language model (LLM);
receiving, from a user of a client device, a user query via a chatbot application, wherein the user query relates to an order of the user;
for one or more iterations, performing using the agent:
providing a prompt for input to the LLM, the prompt specifying at least one or a combination of the user query, contextual information, the set of tools, and a request to output an action;
receiving a response for a current iteration generated by executing the LLM on the prompt;
parsing the response from the LLM to extract a selected action and action inputs for the selected action; and
triggering execution of a respective tool corresponding to the selected action with the action inputs to generate one or more observations;
generating, based on the one or more observations, a response to the user query; and
transmitting the response to the client device to cause display of the response at the client device.

10. The non-transitory computer readable storage medium of claim 9, the steps further comprising:
creating an indexed database indexing one or more articles and documents from a knowledge base, wherein the one or more tools include a tool for identifying portions of the indexed database that are relevant to an input, and
wherein for at least one iteration, the selected action is triggering execution of the tool using the user query as the action inputs to identify portions of the indexed database that are relevant to the user query.

11. The non-transitory computer readable storage medium of claim 9,
wherein the one or more tools include a tool for invoking an application programming interface (API) call to an endpoint, and
wherein for at least one iteration, the selected action is triggering the tool to invoke the API call with the action inputs as parameters to the API call.

12. The non-transitory computer readable storage medium of claim 9,
wherein the one or more tools include a tool for executing code in a REPL environment, and
wherein for at least one iteration, the selected action is triggering the tool to execute code specified in the action inputs within the REPL environment.

13. The non-transitory computer readable storage medium of claim 9, wherein the contextual information includes a user identifier associated with a user of the user query and an order identifier associated with an order of the user.

14. The non-transitory computer readable storage medium of claim 9, the steps further comprising:
receiving a second user query;
determining that the second user query should not be responded to by the chatbot application; and
routing the second user query to a live agent.

15. The non-transitory computer readable storage medium of claim 9, wherein the prompt includes a description for each tool in the set of tools, and one or more inputs for each tool in the set of tools.

16. The non-transitory computer readable storage medium of claim 9, wherein accessing the external data comprises accessing data provided by an online system.

17. A computer system comprising:
one or more computer processors; and
a non-transitory computer readable storage medium storing instructions that when executed by one or more computer processors cause the one or more computer processors to perform steps comprising:
configuring a set of tools on an interface system, wherein at least one or more tools are each configured to access external data, and wherein the interface system hosts an agent configured to access a large language model (LLM);
receiving, from a user of a client device, a user query via a chatbot application, wherein the user query relates to an order of the user;
for one or more iterations, performing using the agent:
providing a prompt for input to the LLM, the prompt specifying at least one or a combination of the user query, contextual information, the set of tools, and a request to output an action;
receiving a response for a current iteration generated by executing the LLM on the prompt;
parsing the response from the LLM to extract a selected action and action inputs for the selected action; and
triggering execution of a respective tool corresponding to the selected action with the action inputs to generate one or more observations;
generating, based on the one or more observations, a response to the user query; and
transmitting the response to the client device to cause display of the response at the client device.

18. The computer system of claim 17, the steps further comprising:
creating an indexed database indexing one or more articles and documents from a knowledge base, wherein the one or more tools include a tool for identifying portions of the indexed database that are relevant to an input, and
wherein for at least one iteration, the selected action is triggering execution of the tool using the user query as the action inputs to identify portions of the indexed database that are relevant to the user query.

19. The computer system of claim 17,
wherein the one or more tools include a tool for invoking an application programming interface (API) call to an endpoint, and
wherein for at least one iteration, the selected action is triggering the tool to invoke the API call with the action inputs as parameters to the API call.

20. The computer system of claim 17,
wherein the one or more tools include a tool for executing code in a REPL environment, and
wherein for at least one iteration, the selected action is triggering the tool to execute code specified in the action inputs within the REPL environment.
